(19) United States
(12) Patent Application Publication
(10) Pub. No.: US 2020/0076818 A1
(43) Pub. Date: Mar. 5, 2020

(54) RISK-AWARE SESSIONS IN ROLE BASED ACCESS CONTROL SYSTEMS AND METHODS OF USE

(71) Applicant: THE BOARD OF REGENTS OF THE UNIVERSITY OF TEXAS SYSTEM, Austin, TX (US)

(72) Inventors: Ram Krishnan, San Antonio, TX (US); Ravinderpal Singh Sandhu, Helotes, TX (US); Khalid Bijon, San Antonio, TX (US)

(21) Appl. No.: 14/505,388

(22) Filed: Oct. 2, 2014

Related U.S. Application Data
(60) Provisional application No. 61/886,639, filed on Oct. 3, 2013.

(51) Int. Cl. H04L 29/06

(52) U.S. Cl. CPC H04L 63/105

(57) ABSTRACT

Disclosed herein is a system and method of using the same for risk-aware sessions in role based access control. Role Based Access Control (RBAC) has received considerable attention as a model of choice for simplified access control. Risk awareness in access control has emerged as an important research theme to mitigate risks involved when users exercise their privileges to access resources under different contexts such as accessing a sensitive file from work versus doing the same from home. In an embodiment, incorporated herein are “risks” in RBAC—in particular, in RBAC sessions. Described herein are systems comprising the RBAC model in conjunction with incorporating risk awareness in sessions where the risk is bounded by a session-based “risk-threshold.” Further described herein are systems comprised of frameworks of models for role activation and deactivation in a session based on this threshold.

### STATEMENT REGARDING FEDERALLY SPONSORED RESEARCH OR DEVELOPMENT

This invention was made with government support under grant no. FA9550-08-1-0265 awarded by Air Force Office of Scientific Research. The government has certain rights in the invention.

### CROSS-REFERENCE TO RELATED APPLICATIONS

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a system and method of use directed to an access control system. More specifically, the present invention relates to a system and method of use for risk-aware sessions in role based access control systems.

### BACKGROUND OF THE INVENTION

Without limiting the scope of the disclosed systems and methods, the background is described in connection with a risk based access control system. Over the past decade, considerable research has been conducted in Role Based Access Control (RBAC) [12]. In RBAC, session is an important risk mitigating feature in which a user interacts with the system by enabling a limited set of roles (although, in the absence of constraints it is feasible for the user to sequentially interact with the system using all the privileges based on roles assigned to that user). Risk awareness in access control is a new but prominent issue as the need for enabling access in an agile and dynamic way has emerged. Some references in the prior art are disclosed in this arena [2-4, 7, 9-11], mainly, attempting to combine risk with different access control systems. According to [10], a practical risk aware access control system should have a risk assessment process relevant to the context of the application as well as proper utilization of the estimated risk for granting or denying access requests. A risk aware access control system differs from traditional access control systems in that it permits/denies access requests dynamically based on estimated risk instead of predefined access control policies which always give same outcomes.

The concept of a session in classical RBAC has dual motivation. It serves as a basis for dynamic separation of duties whereby some roles cannot be combined in a single session. It also serves as a basis for a user to exercise least privilege with respect to powerful roles that can remain inactivated until they are really required. Both motivations are conceptually related to risk.

Several approaches have been utilized for combining risk issues in different access control systems. Kandala et al [7] provide a framework that identifies different risk components for a dynamic access control environment. The Jason report [10] proposes three core principles for a risk-aware access control system: measuring risk, identifying tolerance levels of risk and controlling information sharing. Cheng et al [4] give a model to quantify risk for access control and provide an example for multilevel information sharing. Ni et al [9] utilizes a model for estimating risk and induce fuzziness in the access control decision of the Bell-Lapadula model. Moloy et al [8] utilizes a risk-benefit approach for avoiding communication overhead in distributed access control. There are also other approaches to achieve automated threat response in dynamically changing environments. Autrel et al [1] utilizes a reaction policy model for organizations in dynamic organizational environment and different threat contexts (e.g. buffer overflow, brute force attack, etc.). Debar et at [5] utilizes a more sophisticated approach in which threat contexts and new policy instances are dynamically derived for every threat alert. All of these approaches focus on how to estimate risk. In contrast, what is needed is how to utilize such risk measures in a novel way in role activation and deactivation in an RBAC model to mitigate threats.

While the aforementioned references in the prior art disclose several approaches, none fulfill the need for an RBAC system for managing and mitigating risks dynamically by session.

What is desired, therefore, is a system that manages risks dynamically by sessions bounded by at least one risk threshold.

### BRIEF SUMMARY OF THE INVENTION

Accordingly, it is an object of the present invention to provide a system that manages risk dynamically by session in a novel way. It is a further object of the present invention to provide a system that mitigates the risk dynamically by session.

These and other objects of the present invention are achieved by a system that is configured to utilize risk thresholds. A system's capabilities are enriched herein, that implements RBAC, by dynamically controlling user activities in a session according to risk in the current situation. There are three different points of time and processes a risk could be estimated in a session: static, dynamic and adaptive. Two separate system configurations/frameworks for role activation models where the user-system interaction is either role level or permission level are disclosed. In an embodiment, the system is configured to automatically perform a role deactivation process by which a session with adaptive risk threshold can decrease access capability of a user in session whenever it is necessary.

In summary, the present invention discloses novel systems and methods for an RBAC system for managing and mitigating risks dynamically by session

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a system architecture diagram of a simple PDP/PEP based access control enforcement model in accordance with embodiments of the disclosure;

FIG. 2 is a block diagram of role activation in role level user interactions within the risk based access control system with risk-aware sessions in accordance with embodiments of the disclosure;

FIG. 3 is a block diagram of role activation in permission level interactions within the risk based access control system with risk-aware sessions in accordance with embodiments of the disclosure;

FIG. 4 is a block diagram of automated role deactivation within the risk based access control system with risk-aware sessions in accordance with embodiments of the disclosure;

FIG. 5 is a system architecture diagram of a risk based access control system with risk-aware sessions in accordance with embodiments of the disclosure.

### DETAILED DESCRIPTION OF THE INVENTION

Described herein is a method and system to set a risk-threshold that limits a user's attempt to activate roles to enhance the session's access capability. The numerous innovative teachings of the present invention will be described with particular reference to several embodiments (by way of example, and not of limitation).

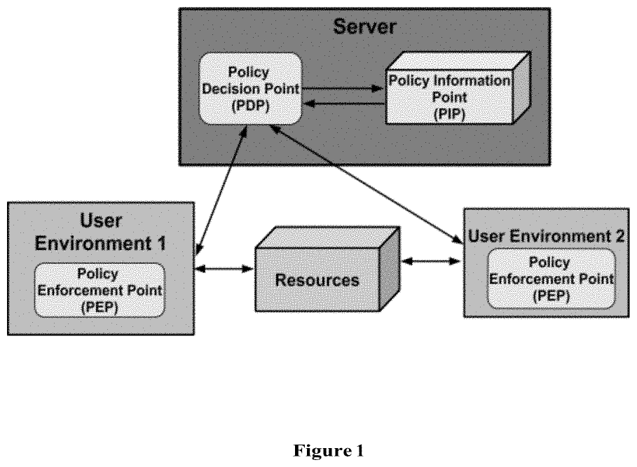

Consider a typical access control enforcement framework that consists of one or more policy information, decision and enforcement points (PIP, PDP and PEP respectively). A PEP enforces policy decisions made by the PDP on the client. The PDP makes this decision by consulting one or more PIPs. The PDP/PIP may reside in a central server while the PEPs could be implemented in different user environments. FIG. 1 illustrates such an access control enforcement framework in which there are two different user environments each containing a PEP. For each user access request, the PEP contacts the PDP residing in the centralized server. The PDP consults the PIP for each requested access and responds with an authorization decision to the PEP.

Consider how RBAC role activation and deactivation would work under this enforcement model. When a user creates a session and requests to activate a set of roles, the PEP on the user's system forwards the request to the PDP. The PDP responds with allow or deny after verifying whether the user has been assigned the requested set of roles to be activated. If allowed, the PDP sends the aggregate set of permissions based on the role permission assignment information for each role in the requested role set (by consulting with the PIP). From here on, when the user requests to access a specific resource, the PEP checks if the request is allowed based on this set of permissions without having to contact the PDP for each request. Note that if the user needs to activate a new role, the PEP would have to verify this with the PDP and fetch the corresponding additional set of permissions if allowed. Also, if a role is deactivated by the user, the PEP can appropriately adjust the permissions dropping those that are exclusively authorized by the deactivated role.

Now, if the session were to be compromised or hijacked, say by some malware in the user's computer, the attacker would be freely able to operate with the privileges of the user enabled in that session. The attacker could completely impersonate that user in the system by further activating all the roles of the user. A session risk threshold can mitigate this threat. For instance, if each permission can be assigned a risk value, the total risk of a role can be computed (e.g., as the sum of risk of each permission assigned to that role [11]). The session risk-threshold defines the maximum risk that the session can carry at any time. Effectively, the threshold limits the set of roles that can be activated in a given session. Under this scenario, if the session were to be compromised, the threshold places an upper limit on the maximum damage that can occur. For instance, an intelligent system can detect the malicious context within which a user is operating and place a very low risk threshold that prevents the user from ever activating certain powerful and hence highly risky roles in that session. This is a useful and practical mitigation strategy given that “bring your own device” and smart phones have become common platforms in the modern IT environment.

The system is further described where a session risk-threshold has already been established or can be computed. That is, the manner in how to compute session risk based on user's context in this application is not limited to one approach and may take many embodiments. Several physical configurations may be implemented such as in a centralized server or a disparate server configuration. In an embodiment, the minimum physical configuration is at least one processor and a storage medium that stores computer program logic that is executable by the one or more processors for managing the RBAC.

In an embodiment, the system categorizes risk-threshold of sessions into three different types based on when and how it is computed as well as type of information it uses.

Risks-Aware RBAC Session Characteristics

The characteristics of role activation and deactivation can vary depending on when and how the session risk-threshold is computed. In an embodiment, there are at least three points in time at which it may be computed. Each of these points may be termed as static, dynamic and adaptive respectively.

Session with Static Risk-Threshold (SSR): In SSR, every session of a user has a constant risk-threshold. An administrator might statically calculate session risk-threshold for a user by evaluating several properties, e.g., user's credential and assigned role-set, and it remains unchanged for every session of a given user. This session is useful to enforce certain well-known RBAC functionalities such as cardinality constraint or dynamic separation of duty. For instance, static risk-threshold value could be such that a user could not activate and keep more than two roles in a session simultaneously.

Session with Dynamic Risk-Threshold (SDR): In SDR, the risk-threshold may vary from session to session for a given user. Unlike SSR, the risk should be estimated before every session creation. Thus certain dynamic properties of the user and system (e.g. time, place and currently activated roles) might influence this process. Once calculated, risk-threshold remains unchanged in a session.

Session with Adaptive Risk-Threshold (SAR): This is the most sophisticated session risk-threshold estimation model. In SAR, session risk-threshold is first estimated before the creation of the session, as in SDR. However, based on the user activities during the session, the system could decrease or increase the value. Therefore, the system needs to monitor user activities during the session. Any detected abnormal or malicious activities should lower the risk-threshold and thereby limit further suspicious activities. Therefore, a system automated role deactivation process is required in SAR to deactivate risky roles according to adjusted risk threshold and prevent further re-activation of such roles.

In an embodiment, each role is associated with a quantified risk value that is indicative of the criticality of that role. Given this, the session risk-threshold as estimated by various schemes discussed above (SSR, SDR and SAR) limits what activities a user can perform in that session. Risk measurement of a role might be affected by several factors, e.g., the cost of the permissions that are assigned to it and role dependencies. Any role activation request triggers the system to verify the session risk-threshold with the risk of this new role to be activated. If activation of a role does not exceed the session risk-threshold then the activation is permitted. Otherwise, it is denied or could cause deactivation of already activated roles from the session.

In a session, any user attempt to perform a task might require role activation which could happen either by a user's direct attempt to activate a role in role level user-system interaction or user's attempt to perform a task in the system (i.e., exercise a permission) with permission level interaction. In role level interaction, a user explicitly mentions the role that she wants to activate. In permission level, the system needs to find if there is a role assigned to the user with the requested permission. Role activation could be completely controlled by the user or could be aided or completely automated by the system without user involvement. Also, certain roles may need to be deactivated as a consequence of activation of other roles to maintain session's risk under the threshold.

User Driven Role Activation Frameworks

In an embodiment, the system is configured as follows. A session risk_threshold parameter places an upper bound on the risk that a session can carry. A present_risk parameter specifies the current risk of a session. As mentioned earlier, many techniques could be employed to estimate these two parameters. Presented herein, in an embodiment, the system is configured with frameworks of models for role activation given these two parameters.

Role Level Interaction

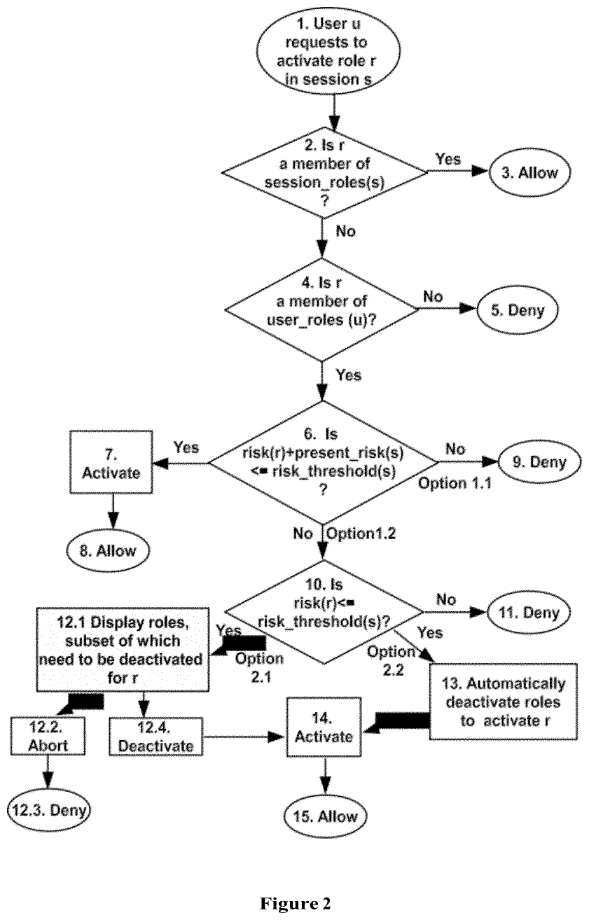

Users in RBAC request to activate a particular role in a session and the system could allow or deny the request. FIG. 2 shows the steps involved in this process. It starts with a user request to activate a role in a session and ends with an Allow or Deny decision. After receiving a request from user u, the system first checks if the requested role r is available in session_roles(s), which is the set of currently activated roles in session s. If so, the system returns otherwise, it checks the assigned_roles set that contains all roles authorized for u. The request is simply denied if role r is not present in assigned_roles.³ Otherwise, the system compares if addition of r increases present risk of the session beyond the risk threshold. If not, the activation is allowed. Note that present_risk is the combined risk of all activated roles in a session that indicates the risk the session is currently carrying. If the risk_threshold would be exceeded, the system can either deny the request or attempt to deactivate some prior activated role(s) from the session in order to reduce present risk before activating r, provided the risk of r is less than session risk_threshold. If so, the system could automatically deactivate unnecessary roles. Alternatively, it can display possible combinations of roles for deactivation from which the user might select one option. On successful deactivation, the system activates the requested role. The user may also cancel deactivation and abort the activation process. ³ For simplicity, core RBAC with no hierarchy among the roles is considered. Extension to hierarchical RBAC is straightforward and understood with the described configurations.

There are three different types of activation models that could be constructed by choosing different options from this framework:

Strict Activation: This activation could be constructed if option 1.1 in FIG. 2 is chosen. In this approach, the system activates the requested role if it satisfies risk_threshold or denies otherwise.

Activation with System Guided Deactivation: Combination of options 1.2 and 2.1 in FIG. 2 yields this configuration. If activation of a role exceeds the risk_threshold, the system suggests the user to deactivate prior activated roles from session_roles to keep present_risk within session risk_threshold.

Activation with System Automated Deactivation: In this configuration the system automatically deactivates roles from session_roles for activating a role. This configuration could be constructed with options 1.2 and 2.2 in FIG. 2.

Many strategies could be employed at different levels of sophistication for each of the above models. For example, in system automated deactivation above, the system could employ simple algorithms for deactivation such as least recently used role or more sophisticated algorithms based on machine learning and heuristics that captures user activity patterns and selects the most appropriate role.

Permission Level Interaction

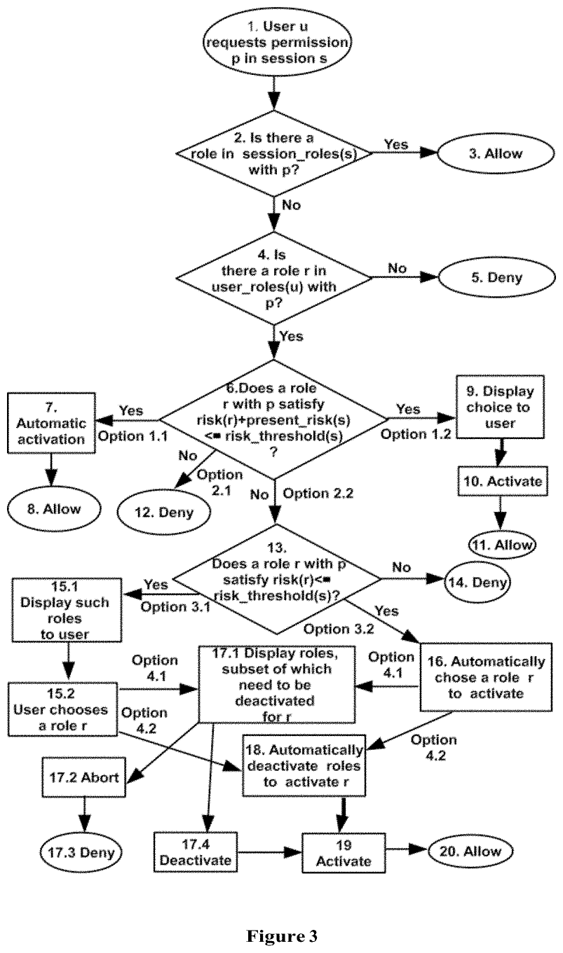

In many practical systems, user-system interaction is permission level instead of role level. Users keep doing their job and the system automatically checks authorization, e.g., a bank teller may try to obtain a statement for a customer and the system checks if she has the necessary role(s) activated in the session. If not, it may find an appropriate role to be activated to enable the user's action. FIG. 3 shows a configuration for role activation for such interactions. It starts when a user tries to exercise permissions or perform a task and ends with an Allow or Deny. A request for permission p from user u can be approved if p is present in the session_permissions set. Otherwise, the system finds a role assigned with p in the assigned_roles set of u. The request is simply denied if no such role is found. Otherwise, if there is such a role r, the system activates it provided increased present_risk from activation of r stays within the risk_threshold of the session s. If there is more than one such role, the system might automatically select and activate one. There are different ways this selection could be performed, e.g., less risky role, role with minimum permissions or role relevant to user activities in that context. Alternatively, the system in an embodiment will ask the user to select one of them for activation. There might be a case when there are multiple roles with p whose individual risk is less than risk_threshold of s, however, activation is not possible without deactivation of other roles to maintain present_risk under the threshold. At this point, following the selection of a role r to be activated by the user, the system determines roles that need to be deactivated. As in role level interaction, there are two different deactivation processes. Finally, a successful deactivation allows activation of r. From this framework different activation models could be configured as follows.

Strict Role Activation: Activation is allowed if it satisfies-risk_threshold of the session, otherwise denied. This model could be constructed by combining either options 1.1 and 2.1 or 1.2 and 2.1 in FIG. 3.

System Automated Role Activation: In an embodiment, the system automatically chooses a role r for activation of the requested permission p and the activation process might need deactivation of prior activated roles. This deactivation could be done automatically or by user's choice. Such an activation model could be constructed by combining options 1.1, 2.2, 3.2 and 4.1 or 1.2, 2.2, 3.2 and 4.2 or 1.1, 2.2, 3.2 and 4.1 or 1.1, 2.2, 3.2 and 4.2 in FIG. 3.

System Guided Role Activation: In an embodiment, the system asks the user to select a role r from a possible set of roles with requested permission p and activation of any of them might cause deactivation of prior activated roles. This model could be constructed by choosing either options 1.2, 2.2, 3.1 and 4.1 or options 1.2, 2.2, 3.1 and 4.2 in FIG. 3.

Risks-Adaptive Role Deactivation

Sessions with static or dynamic risk threshold (SSR/SDR) will have certain limitations. A malicious entity that takes control of a session may still obtain all the power of the user that owns the session in a piecemeal manner. For example, suppose that a session risk_threshold is set at 30 and that every role assigned to the user of the session has a risk value below 30. Even though the aggregate risk of all roles assigned to the user may be above the risk_threshold of 30, the malicious entity can activate and deactivate one role at the time and accomplish most, if not all the tasks that the user is capable of Since SSR and SDR schemes do not adjust the session risk_threshold over the period of the session, they cannot address this issue. However, sessions with adaptive risk_threshold (SAR) adjust session risk threshold value by monitoring the activities in a session. By adaptively reducing the threshold, the user is forced to deactivate certain roles and are prevented from further reactivation of such roles. This contains further damages that could be caused by a malware that takes control of the session. Following the earlier example, in an SDR scheme, a malware would never be able to activate roles whose risk value is above 30 since the risk_threshold is set at 30. Thus the risk_threshold could prevent certain roles from being ever activated in a suspicious session, for example.

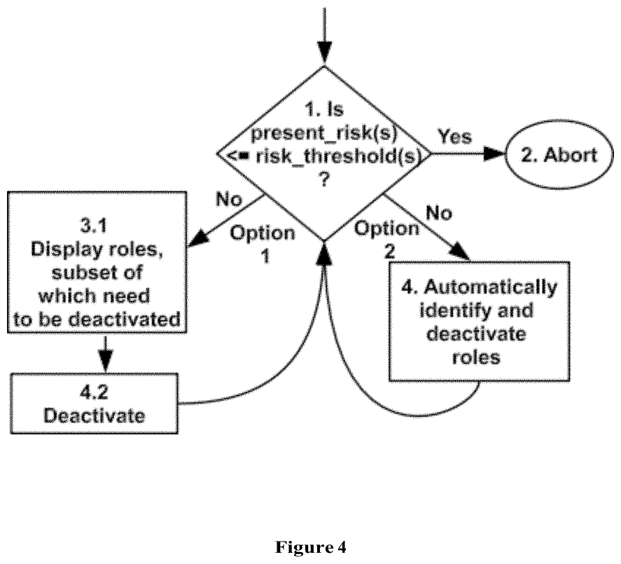

FIG. 4 shows a framework configuration for a system embodiment with automated role deactivation models. A continuous monitoring process may be necessary to detect abnormal or malicious activities within a session. On successful detection, the system lowers the risk_threshold to stop certain activities. Every time the threshold changes, the system automatically calls the deactivation function to remove certain roles affected by the changing threshold. There are two different ways this process could happen: the system could automatically deactivate the roles or force the user to deactivate them by providing her some choices on what roles to be deactivated. Unlike SSR and SDR, this system initially might grant certain user permissions in less risky situation and be able to revoke them if the situation becomes more risky.

Formal Specifications

The following embodiment is for a system configuration with guided role activation for a session with dynamic risk_threshold (SDR) in permission level user-system interaction. This configuration could be constructed by selecting options 1.2, 2.2, 3.1 and 4.1 in FIG. 3. This formal specification configuration extends the NIST Core RBAC model [6].

Overview of NIST Core RBAC

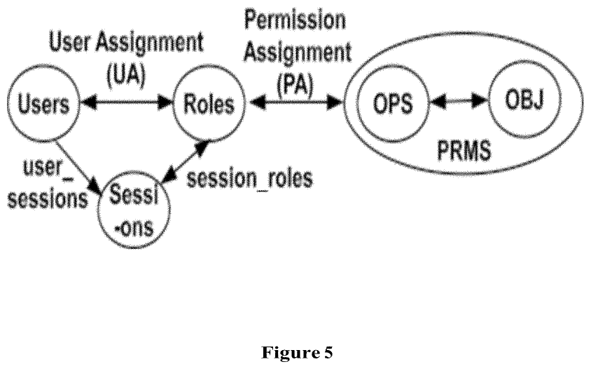

Core RBAC provides a fundamental set of elements, relations and functions required for a basic RBAC system. These elements are shown in FIG. 5. The set of elements contain users (USERS), roles (ROLES), operations (OPS), objects (OBJ) and permissions (PRMS). There are many-to-many mapping relations such as user-to-role (UA) and permission-to-role (PA) assignment relations. PRMS=2^{OPS×OBJ}, is a set of permissions in which each (OPS, OBJ) pair indicates an operation that could be performed on an object. The Core RBAC model also includes a set of sessions (SESSIONS) where each session is a mapping between a user and an activated subset of roles that are assigned to the user. Each session maps one user to a set of roles, that is, a user establishes a session during which the user activates some subset of roles that he or she is assigned. Each session is associated with a single user and each user is associated with one or more sessions. A session_roles function gives the roles activated in the session and a user_sessions function gives the set of sessions that are associated with a user. Details of the relation and functional specification of this model are provided in [6].

In this system configuration, each permission is associated with a risk value that is indicative of damages that can occur if compromised. For simplicity, the risk of a role is considered as the sum of all permissions assigned to it. Here a user creates a session and continues requesting permissions to perform her job. During session creation, the system dynamically calculates session risk_threshold and keeps activating roles for requested permissions within the threshold. Both permission risk and risk_threshold are positive real numbers ( [symbol] ≥0). We formally define:

assigned_risk: PRMS→ [symbol] ≥0, a mapping of permission p to a positive real value, which gives the risk assigned to a permission.

risk_threshold: SESSIONS→ [symbol] ≥0, a mapping of session s to a positive real number that gives the maximum risk the session could contain.

present_risk: SESSIONS→ [symbol] ≥0, a mapping of session s to a positive real number that gives the present risk value of the session.

In an embodiment, the above three pieces of information are always available as part of the system. It also contains administrative functions to create and maintain elements and system functions for session activity management. In the following, note that a regular user can only call the CreateSession and PerformTask functions. All the other functions are administrative/system functions. In the function parameter, NAME is an abstract data type whose elements represent identifiers of various entities in the RBAC system.

AssignRisk: This administrative function assigns a risk value to a
permission.
1: function AssignRisk(ops, obj : N AM E, risk : [symbol] ≥0 )
2: if ops ϵ OP S and obj ϵ OBJ then
3: assigned risk'(ops, obj) ← risk
4: end if
5: end function

```
RoleRisk: This function returns estimated risk of a role. It takes role as
an input and returns the sum of its assigned permissions' risk.
  1: function RoleRisk(role : N AM E, result: [symbol]  ≥0 )
  2:  /*The value of result is initially 0*/
  3:  if role ϵ ROLES then
  4:  for all ops ϵ OP S and obj ϵ OBJ do
  5:  if ((ops, opj) → role) ϵ PA then
  6:  result ← result+ assigned risk (ops,obj)
  7:  end if
  8:  end for
  9:  end if
10: end function
```

CreateSession: A user creates a session using this function. Initially the session does not contain any role. It utilizes an evaluate_risk function to calculate the risk_threshold of a given user. Functionality of evaluate_risk should be application specific, thus, we do not specify the details of this function. The present_risk contains the sum of activated roles' risk in the session which is initially 0.

1: function CreateSession(user : N AM E, session : N AM E)
2: if user ϵ USERS and session ∉ SESSION S then
3: SESSION S' ← SESSION S ∪ {session}
4: user_sessions'(user) ← user_sessions(user) ∪ {session}
5: risk_threshold'(session) ← evaluate_risk(session, user)
6: present_risk'(session) ← 0
7: end if
8: end function

PerformTask: In a session, a user can invoke this function to access a permission. Note that, this is the first step of the flowchart shown in FIG. 3. This function takes a access request of the user in a session and calls CheckAccess to verify if the necessary role is activated in that session. If CheckAccess returns true it allows the user request and deny otherwise.

```
  1: function P erformTask(user, session, obj, ops : N AM E,
result : BOOL)
  2:  if sessionϵSESSION S and opsϵOP S and
  3:  objϵOBJS and userϵ USERS then
  4:  if CheckAccess(user, session, obj, ops) = true then
  5:  result ← true
  6:  else
  7:  result ← false
  8:  end if
  9:  end if
10: end function
```

CheckAccess: CheckAccess is called for each user access requests to check whether the session has the necessary role activated. If the role is not activated, it calls AddActiveRole for activating the necessary role if any. On successful activation, it returns true.

```
  1: function CheckAccess(user, session, obj, ops : N AM E,
  result : BOOL)
  2:  if sessionϵSESSION S and opsϵOP S and
  3:  objϵOBJS and userϵ USERS then
  4:  for all r ϵ session_rales(session) do
  5:  if ((ops, obj) → r) ϵ PA then
  6:  result ← true; return
  7:  end if
  8:  end for
  9:  if AddActiveteRole(user, session, obj, ops) = true then
10:  result ← true
11:  else
12:  result ← false
13:  end if
14:  end if
15: end function
```

AddActiveRole: Unlike RBAC₀, this function cannot be explicitly invoked by a user, rather, it is called by the system to activate a role for a permission requested by a user within a session. First, the function checks assigned_users set to find if there is a role with the requested permission that is authorized for the user. If there is no such role, it returns false as activation failure. If roles are present and could be activated within the session risk_threshold, it asks the user to select a role. After the user's selection, it activates the role and returns true. Alternatively, roles with the requested permission might be available with risk value less than the session's risk_threshold, however, its addition would exceed the present risk due to already activated roles in the session. In such cases, the system displays the roles that could be deactivated and the user selects some of them. Then the Deactivation function is called and after necessary deactivation, the system activates the selected role and returns true, otherwise, returns false.

```
  1: function AddActiveRole(user, session, obj, ops : N AM E, result : BOOL)
  2:  if sessionϵSESSION S and opsϵOP S and
  3:  objϵOBJS and userϵU SERS then
  4:  roleOptions ← {Ø} /*Set of roles to display, initially empty set*/
  5:  /*Find roles that can be activated within risk threshold*/
  6:  for all r ϵ ROLES and user ϵ assigned users(r) do
  7:  if ((ops, obj) → r) ϵ P A and session_risk(session)+
  8:  RoleRisk(r) ≤ risk_threshold(session) then
  9:  roleOptions' ← roleOptions ∪ {r}
10:  end if
11:  end for
12:  if roleOptions/= {Ø} then /* If there are roles to activate*/
13:  sr = SelectRoles(roleOptions) /* Roles are displayed to user* /
                /*and user select role sr to activate and system activates the sr*/
14:  session_roles'(session) ← session_role(session) ∪ {sr}
15:  session_risk'(session) ← session_risk(session) + RoleRisk(r)
16:  result ← true; return
17:  else/*Find relevant roles with RoleRisk less than the risk threshold*/
18:  for all r ϵ ROLES and user ϵ assigned_users(r) do
19:  if ((ops, obj) → r) ϵ P A and RoleRisk(r)≤
20:  risk_threshold(session) then
21:  roleOptions' ← roleOptions ∪ {r}
22:  end if
23:  end for
24:  if roleOptions/= {Ø} then /*User selects roles from roleOptions*/
25:  /*and Deactivation function is called*/
26:  sr ← SelectRoles(roleOptions)
27:  if Deactivation(session, sr) = true then
28:  session_roles'(session) ← session_role(session) ∪ {sr}
29:  session_risk'(session) ←
30:  session risk(session)+RoleRisk(sr)
31:  result ← true; return
32:  end if
33:  end if
34:  end if
35:  end if
36:  result ← false
37: end function
```

Deactivation: This function deactivates the roles from the session to activate the requested role sr. On successful deactivation, it returns true and false otherwise. Similar to AddActiveRole this function cannot be invoked by a user.

```
  1: function Deactivation(session, sr : N AM E, result : BOOL)
  2:  if sessionϵSESSIONS then
  3:  roleOptions ← {Ø} /*Set of roles to display, initially empty
            set*/
  4:  /*Create roleOptions that contains roles to be deactivated*/
  5:  for all r ϵ session roles(session) do
  6:  if session_risk(session)+ RoleRisk(rs) − RoleRisk(r)
  7:  ≥ risk_threshold(session) then
  8:  roleOptionsp' ← roleOptions ∪ {r}
  9:  end if
10:  end for
11: /*Call DeactivationSelect to get approval from user to deactivate
roleOptions* /
12:  if DeactivationSelect(roleOptions) = true then
13:  for all r ϵ roleOptions do
14:  session_roles'(session) ← session_role(session) −
                    {r}
15:  session_risk'(session) ← session_risk(session)−
                    RoleRisk(r)
16:  end for
17:  result ← true; return
18:  end if
19:  end if
20:  result ← false
21: end function
```

The disclosed system and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Alternative applications of the disclosed system and method of use are directed to resource management of physical and data systems. Consequently, any embodiments comprising a one component or a multi-component system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The system and/or methods disclosed and claimed herein can be made and executed without undue experimentation in light of the present disclosure. While the system and methods of this invention have been described in terms of preferred embodiments, it will be apparent to those skilled in the art that variations may be applied to the system and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

### REFERENCES

1. F. Autrel, N. Cuppens-Boulahia, and F. Cuppens. Reaction policy model based on dynamic organizations and threat context. DBSec'09. Montreal, Canada, 2009.
2. N. Baracaldo and J. Joshi. A trust-and-risk aware rbac framework: tackling insider threat. SACMAT '12, pages 167-176, New York, N.Y., USA, 2012. ACM.
3. L. Chen and J. Crampton. Risk-aware role-based access control. In 7th International Workshop on Security and Trust Management, 2011.
4. P.-C. Cheng, P. Rohatgi, C. Keser, P. Karger, G. Wagner, and A. Reninger. Fuzzy multi-level security: An experiment on quantified risk-adaptive access control. In Security and Privacy, 2007, pages 222-230, May 2007.
5. H. Debar, Y. Thomas, F. Cuppens, and N. Cuppens-Boulahia. Enabling automated threat response through the use of a dynamic security policy. Journal in Computer Virology, pages 195-210, 2007.
6. D. F. Ferraiolo, R. Sandhu, S. Gavrila, D. R. Kuhn, and R. Chandramouli. Proposed nist standard for role-based access control. ACM Tran. Inf. Sys. Sec., 2001.
7. S. Kandala, R. Sandhu, and V. Bhamidipati. An attribute based framework for risk-adaptive access control models. In Avail., Reliab. and Sec. (ARES), August 2011.
8. I. Molloy, L. Dickens, C. Morisset, P.-C. Cheng, J. Lobo, and A. Russo. Risk-based security decisions under uncertainty. CODASPY '12, 2012.
9. Q. Ni, E. Bertino, and J. Lobo. Risk-based access control systems built on fuzzy inferences. ASIACCS '10, pages 250-260, New York, N.Y., USA, 2010. ACM.
10. M. C. J. P. Office. Horizontal integration: Broader access models for realizing information dominance. In MITRE Corporation, Tech. Rep. JSR-04-132, 2004.
11. F. Salim, J. Reid, E. Dawson, and U. Dulleck. An approach to access control under uncertainty. In Avail., Reliab. and Sec. (ARES), pages 1-8, August 2011.
12. R. Sandhu, E. Coyne, H. Feinstein, and C. Youman. Role-based access control models. Computer, 29(2):38-47, February 1996.

What is claimed is:

1. A role-based access control system comprising:
one or more processors;
and a storage medium that stores computer program logic that is executable by the one or more processors, said computer program logic comprising:
at least one session;
at least one assigned risk;
at least one risk threshold mapped to each session;
and a present risk mapped to each session;
and whereas said system maintains each said present risk for each said session below said risk threshold mapped;

2. The system of claim 1, wherein said computer program logic is further comprised of role level interactions.

3. The system of claim 2, wherein said role level interactions is further comprised of strict activation.

4. The system of claim 2, wherein said role level interactions is further comprised of system guided deactivation.

5. The system of claim 2, where said role level interactions is further comprised of system automated deactivation.

6. The system of claim 2, wherein said role level interactions is further comprised of strict activation, system guided deactivation, and system automated deactivation.

7. The system of claim 1, wherein said computer program logic is further comprised of permission level interactions.

8. The system of claim 7, wherein said permission level interactions is further comprised of strict role activation.

9. The system of claim 7, wherein said permission level interactions is further comprised of system automated role activation.

10. The system of claim 7, wherein said permission level interactions is further comprised of system guided role activation.

11. The system of claim 7, wherein said permission level interactions is further comprised of strict role activation, system automated role activation, and system guided role activation.

12. The system of claim 1, wherein said computer program logic is further comprised of role level interactions and permission level interactions.

13. The system of claim 1, wherein said computer program logic is further comprised of static risk thresholds for said sessions.

14. The system of claim 1, wherein said computer program logic is further comprised of dynamic risk thresholds for said sessions.

15. The system of claim 1, wherein said computer program logic is further comprised of adaptive risk thresholds for said sessions.

16. The system of claim 1, wherein said computer program logic is further comprised of static risk thresholds, dynamic risk thresholds, and adaptive risk thresholds for said sessions.

17. The system of claim 1, wherein said computer program logic is further comprised of static risk thresholds and role level interactions.

18. The system of claim 1, wherein said computer program logic is further comprised of dynamic risk thresholds and role level interactions.

19. The system of claim 1, wherein said computer program logic is further comprised of adaptive risk thresholds and role level interactions.

20. The system of claim 1, wherein said computer program logic is further comprised of static risk thresholds and permission level interactions.

21. The system of claim 1, wherein said computer program logic is further comprised of dynamic risk thresholds and permission level interactions.

22. The system of claim 1, wherein said computer program logic is further comprised of adaptive risk thresholds and permission level interactions.

23. The system of claim 1, wherein said computer program logic is further comprised of adaptive risk thresholds for said sessions and risk adaptive role deactivations.
